(19) United States
(12) Patent Application Publication
(10) Pub. No.: US 2016/0364022 A1
(43) Pub. Date: Dec. 15, 2016

(54) ACTIVE POSITION INDICATOR

(71) Applicant: Sunrex Technology Corp., Taichung City (TW)

(72) Inventor: Shun-Pin LIN, New Taipei City (TW)

(73) Assignee: Sunrex Technology Corp.

(21) Appl. No.: 14/737,182

(22) Filed: Jun. 11, 2015

(51) Int. Cl. G06F 3/0354; G06F 3/041

(52) U.S. Cl. CPC G06F 3/03545; G06F 3/0414

(57) ABSTRACT

A position indicator includes: a receiving electrode to receive a driving signal from a position detector; an amplifying circuit to amplify the driving signal to generate an amplified signal; an oscillating circuit generating an output signal that oscillates for a time period upon satisfaction of a predetermined threshold condition associated at least with the amplified signal and a predetermined trigger level; and a transmitting electrode to transmit the output signal.

### FIELD

This disclosure relates to position indication, and more particularly to an active position indicator.

### BACKGROUND

A conventional active position indicator disclosed in U.S. Pat. No. 8,199,132 is adapted to receive, using a receiving electrode, a driving signal transmitted by a position detector, amplifies and inverts the received driving signal to generate an output signal, and transmits the output signal using a transmitting electrode. As a result, the position detector can detect a position of the conventional active position indicator relative to the position detector.

The conventional active position indicator advantageously has a relatively small tip as compared to a passive position indicator, but has the following drawbacks:

1. In order to prevent the output signal from oscillating continuously due to positive feedback, a phase difference between the output signal transmitted by the transmitting electrode and the driving signal received by the receiving electrode must be as close as possible to 180 degrees, and a shielding member is required to minimize signal coupling from the transmitting electrode to the receiving electrode. Therefore, it is relatively hard to design the conventional active position indicator.

2. Boost conversion is required. Therefore, the conventional active position indicator has relatively large power consumption.

3. The conventional active position indicator is turned on/off manually by a user. Therefore, it will keep on consuming power when the user forgets to turn it off.

### SUMMARY

Therefore, an object of this disclosure is to provide a position indicator that can prevent an output signal transmitted thereby from oscillating continuously due to positive feedback.

According to this disclosure, there is provided a position indicator operatively associated with a position detector that transmits a driving signal. The position indicator includes a signal processing module. The signal processing module includes a receiving electrode, an amplifying circuit, an oscillating circuit and a transmitting electrode. The receiving electrode is adapted to receive the driving signal. The amplifying circuit is coupled to the receiving electrode, and amplifies the driving signal received by the receiving electrode to generate an amplified signal. The oscillating circuit is coupled to the amplifying circuit for receiving the amplified signal therefrom, and generates an output signal that oscillates for a time period upon satisfaction of a predetermined threshold condition associated at least with the amplified signal and a predetermined trigger level. The transmitting electrode is coupled to the oscillating circuit, and is adapted to transmit the output signal generated by the oscillating circuit.

### BRIEF DESCRIPTION OF THE DRAWINGS

Other features and advantages of this disclosure will become apparent in the following detailed description of the embodiment(s) with reference to the accompanying drawings, of which:

FIG. 1 is a schematic diagram illustrating an embodiment of a position indicator according to this disclosure in use with a position detector;

FIG. 2 is a block diagram illustrating the embodiment;

FIG. 3 is a circuit block diagram illustrating a signal processing module of the embodiment;

FIG. 4 is a timing diagram illustrating an amplified signal, an operating state of a first switch, an operating state of a second switch and an output signal of the embodiment;

FIG. 5 is a timing diagram illustrating a modification of the embodiment; and

FIG. 6 is a circuit block diagram illustrating a power management module of the embodiment.

### DETAILED DESCRIPTION

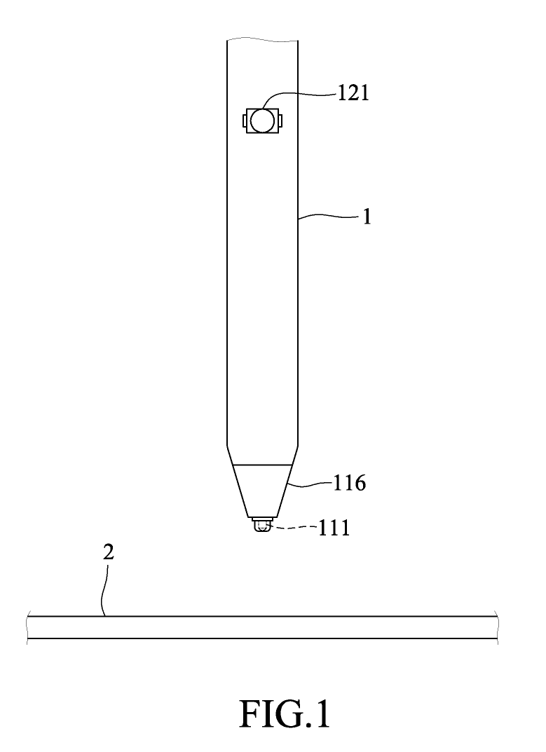

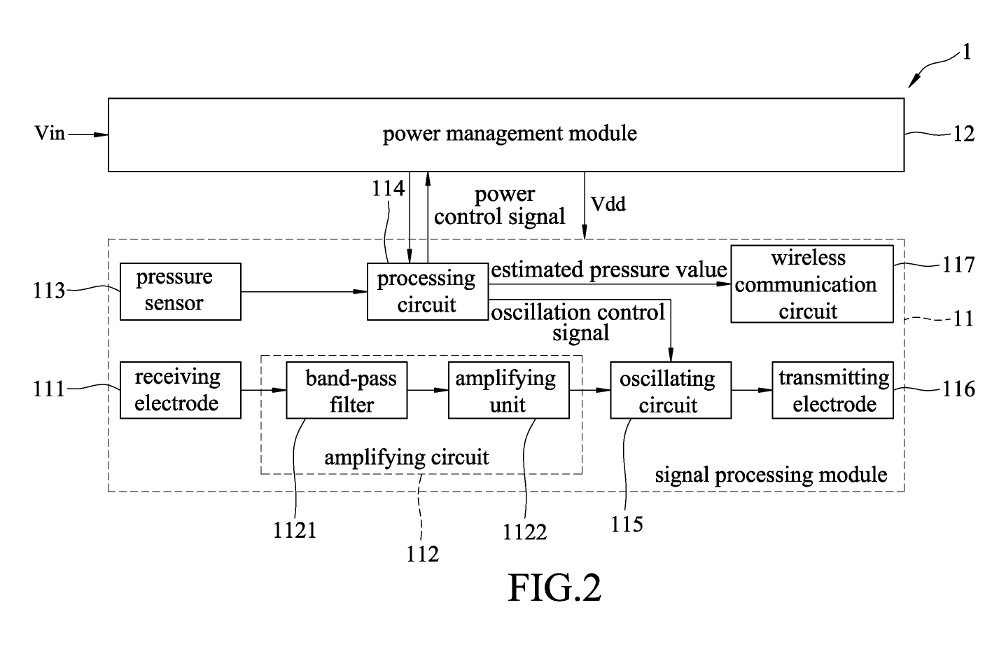

Referring to FIGS. 1 and 2, an embodiment of a position indicator 1 according to this disclosure is an active position indicator, is operatively associated with a position detector 2 transmitting a driving signal, and includes a signal processing module 11 and a power management module 12.

Referring to FIGS. 1, 2 and 3, the signal processing module 11 receives a power supply voltage (Vdd) from the power management module 12, and includes a receiving electrode 111, an amplifying circuit 112, a pressure sensor 113, a processing circuit 114, an oscillating circuit 115, a transmitting electrode 116 and a wireless communication circuit 117.

The receiving electrode 111 is adapted to receive the driving signal transmitted by the position detector 2, among others, if any.

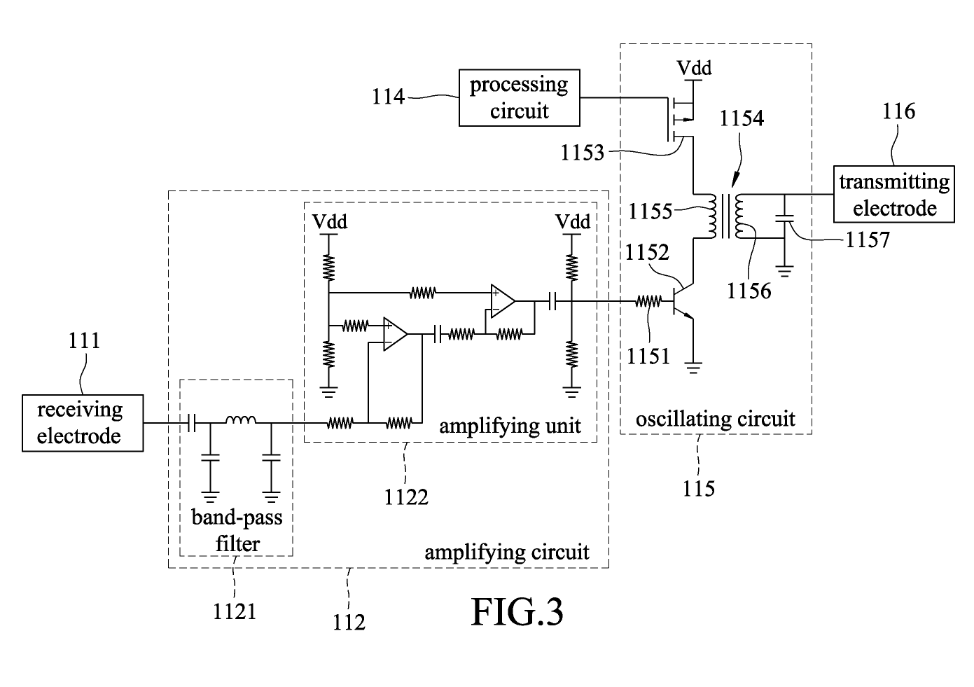

The amplifying circuit 112 is coupled to the receiving electrode 111, and amplifies the driving signal received by the receiving electrode 111 to generate an amplified signal. In this embodiment, the amplifying circuit 112 is a band-pass amplifying circuit, and includes a band-pass filter 1121 and an amplifying unit 1122. The band-pass filter 1121 has a pass band covering a frequency of the driving signal transmitted by the position detector 2, is coupled to the receiving electrode 111, and band-pass filters the signal(s) received by the receiving electrode 111, including the driving signal, to generate a filtered signal. The amplifying unit 1122 is coupled to the band-pass filter 1121 for receiving the filtered signal therefrom, and amplifies the filtered signal to generate the amplified signal. FIG. 3 depicts exemplary configurations of the band-pass filter 1121 and the amplifying unit 1122. However, this disclosure is not limited to such configurations.

The pressure sensor 113 is adapted to sense a contact pressure between the receiving electrode 111 and the position detector 2 to generate a pressure sensing signal. In this embodiment, the pressure sensor 113 is a micro-electro-mechanical system (MEMS) pressure sensor, and is thus relatively stable and precise. However, this disclosure is not limited to this type of pressure sensor.

The processing circuit 114 is coupled to the pressure sensor 113 for receiving the pressure sensing signal therefrom. Based on the pressure sensing signal, the processing circuit 114 estimates the contact pressure between the receiving electrode 111 and the position detector 2 to obtain an estimated pressure value, and generates an oscillation control signal associated with whether the receiving electrode 111 contacts the position detector 2 or not.

The oscillating circuit 115 is coupled to the amplifying unit 1122 of the amplifying circuit 112 and the processing circuit 114 for receiving the amplified signal and the oscillation control signal respectively therefrom, and generates an output signal based on the amplified signal, the oscillation control signal and a predetermined trigger level, such that the output signal begins to oscillate for a time period upon satisfaction of a predetermined threshold condition associated with the amplified signal, the oscillation control signal and the trigger level. In this embodiment, the oscillating circuit 115 includes a resistor 1151, a first switch 1152, a second switch 1153, a transformer 1154 and a capacitor 1157. The resistor 1151 has a first terminal that is coupled to the amplifying unit 1122 of the amplifying circuit 112 for receiving the amplified signal therefrom, and a second terminal. The first switch 1152 is coupled to the second terminal of the resistor 1151, and is operable between an ON state and an OFF state based on a voltage at the second terminal of the resistor 1151. The second switch 1153 is coupled to the processing circuit 114 for receiving the oscillation control signal therefrom, and is operable between an ON state and an OFF state based on the oscillation control signal. The transformer 1154 has a primary winding 1155 that is coupled to the first and second switches 1152, 1153 in series, and a secondary winding 1156 that provides the output signal for assisting the position detector 2 in determining a position of the position indicator 1 relative to the position detector 2. The capacitor 1157 is coupled to the secondary winding 1156 of the transformer 1154 in parallel. When the first and second switches 1152, 1153 both operate in the ON state, the output signal oscillates at a predetermined frequency for the time period. This frequency is determined by an inductance of the secondary winding 1156 and a capacitance of the capacitor 1157, is higher than or equal to that of the driving signal transmitted by the position detector 2. In some embodiments, the frequency of the output signal may be outside the pass band of the band-pass filter 1121 to assist in alleviating/preventing the positive feedback.

The transmitting electrode 116 is coupled to the secondary winding 1156 of the transformer 1154 of the oscillating circuit 115, and is adapted to transmit the output signal.

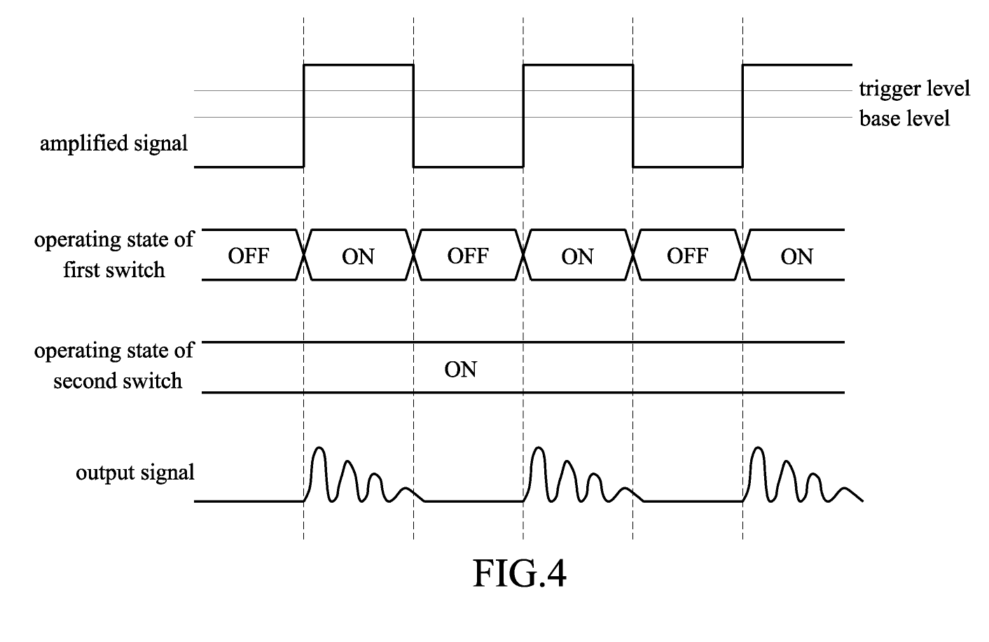

Referring to FIGS. 1 to 4, in this embodiment, the amplified signal varies around a predetermined base level, the trigger level is higher than the base level, and the threshold condition includes that the amplified signal is higher than the trigger level (i.e., the driving signal received by the receiving electrode 111 has a sufficiently large amplitude) and that the receiving electrode 111 contacts the position detector 2. The first switch 1152 operates in the ON state when the amplified signal is higher than the trigger level, and in the OFF state when otherwise. It is noted that, the trigger level may prevent the first switch 1152 from being triggered by a feedback of the output signal. In addition, when the frequency of the output signal is substantially the same as the amplified signal, the trigger level may be adjusted such that a phase difference between the output signal and the amplified signal is substantially 180 degrees, thereby alleviating/preventing the positive feedback. The processing circuit 114 controls the second switch 1153 via the oscillation control signal to operate in the ON state when it is determined that the receiving electrode 111 contacts the position detector 2, and to operate in the OFF state when otherwise. As a result, the first and second switches 1152, 1153 both operate in the ON state and the output signal oscillates for the time period each time the threshold condition is satisfied, and thus the position detector 2 can detect a position of the position indicator 1 relative to the position detector 2 so as to obtain detected position information.

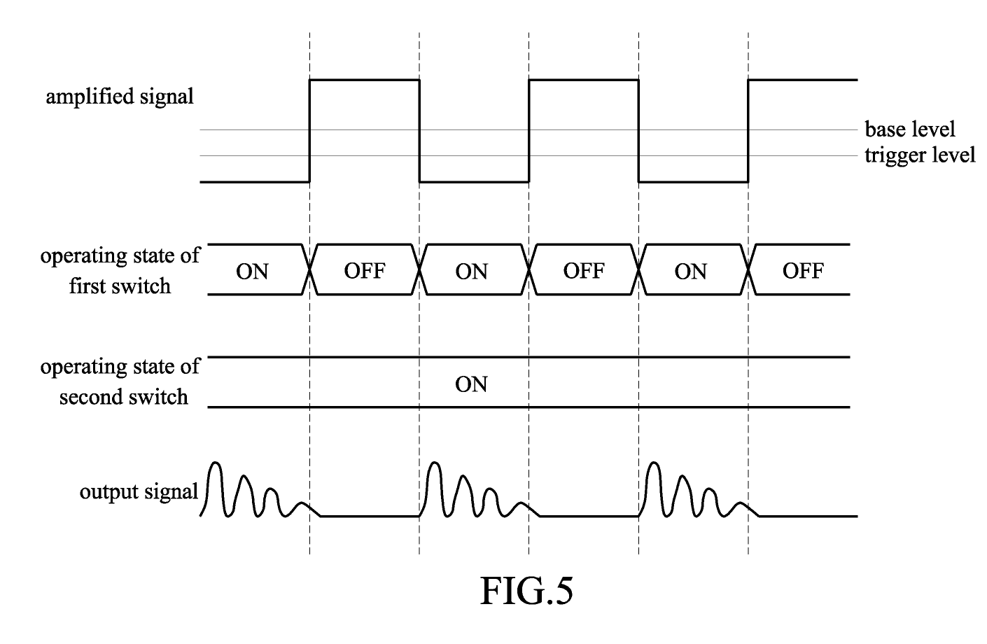

Referring to FIGS. 1, 2 and 5, it is noted that, in a modification of this embodiment, the trigger level may be smaller than the base level by, for example, exchanging the power supply voltage (Vdd) and ground and using a p-type bipolar junction transistor to serve as the first switch 1152, and the threshold condition may include that the amplified signal is lower than the trigger level (i.e., the amplitude of the driving signal received by the receiving electrode 111 is sufficiently large) and that the receiving electrode 111 contacts the position detector 2.

Referring to FIGS. 1 and 2, the wireless communication circuit 117 is coupled to the processing circuit 114 for receiving the estimated pressure value therefrom, generates a communication signal carrying the estimated pressure value, and transmits the communication signal in a wireless manner (e.g., using Bluetooth). As a result, a host (not shown), to which the position detector 2 is installed, can display, based on the estimated pressure value obtained by the position indicator 1 and the detected position information obtained by the position detector 2, a line that has an extension corresponding to a motion of the position indicator 1 on the position detector 2 and that has a width corresponding to the contact pressure between the position indicator 1 and the position detector 2.

Referring to FIGS. 1, 2 and 6, the power management module 12 includes a third switch 121 and a power circuit 122. The third switch 121 has a first terminal that is adapted to receive a source voltage (Vin) (e.g., from a battery (not shown)), and a second terminal, and is operable between an ON state and an OFF state. The power circuit 122 is coupled across the third switch 121 and to the signal processing module 11, receives the source voltage (Vin), and selectively outputs, based on an operating state of the third switch 121 and a power control signal that switches between a first level and a second level, the power supply voltage (Vdd) associated with the source voltage (Vin) to power the signal processing module 11. The power supply voltage (Vdd) is outputted when the third switch 121 operates in the ON state or when the power control signal is at the first level.

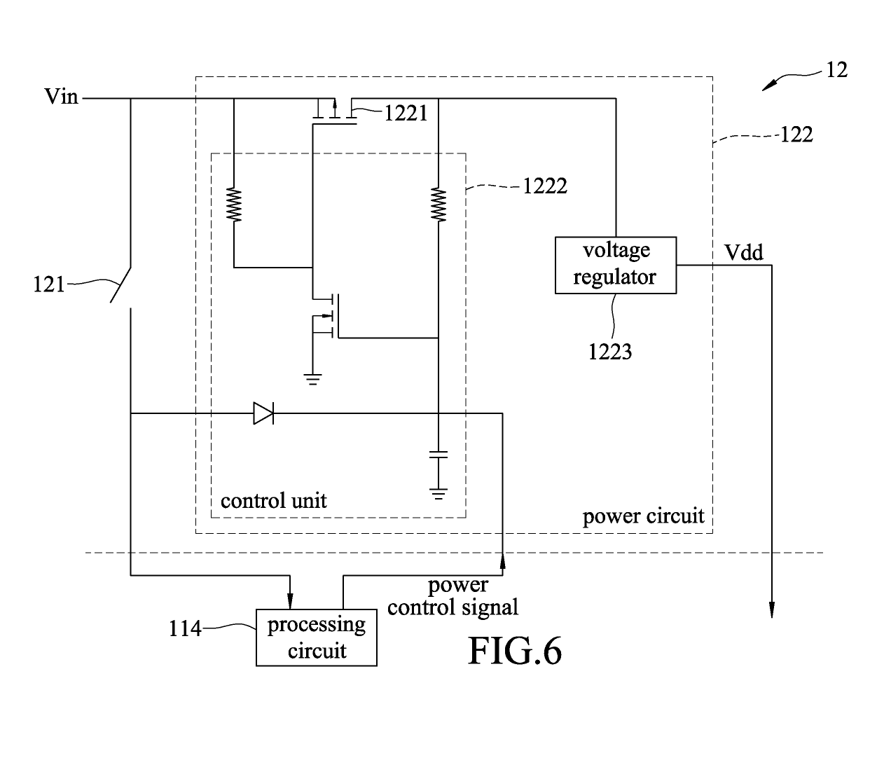

In this embodiment, the third switch 121 is a normally OFF switch, and operates in the ON state when actuated by a user. Moreover, the power circuit 122 includes a fourth switch 1221, a control unit 1222 and a voltage regulator 1223. The fourth switch 1221 is coupled to the first terminal of the third switch 121, and receives the source voltage (Vin). The control unit 1222 is coupled to the second terminal of the third switch 121 and to the fourth switch 1221, receives the power control signal, and controls, based on the operating state of the third switch 121 and the power control signal, operation of the fourth switch 1221 between an ON state and an OFF state such that the fourth switch 1221 operates in the ON state to permit transmission of the source voltage (Vin) therethrough for a duration that the third switch 121 operates in the ON state or for the duration that the power control signal is at the first level. The voltage regulator 1223 is coupled to the fourth switch 1221 for receiving the source voltage (Vin) therefrom, and regulates the received source voltage (Vin) to generate the power supply voltage (Vdd). FIG. 6 depicts an exemplary configuration of the control unit 1222, in which case the first level is a logic high level and the second level is a logic low level. However, this disclosure is not limited to such configuration.

The processing circuit 114 is coupled further to the second terminal of the third switch 121 and the control unit 1222 of the power circuit 122, and generates the power control signal for the control unit 1222 of the power circuit 122 based on the operating state of the third switch 121 and the pressure sensing signal. In this embodiment, the processing circuit 114 performs the following: counting from a predetermined initial value to a predetermined target value; when(ever) the third switch 121 operates in the ON state, setting the power control signal to the first level, and setting the counting to the predetermined initial value (i.e., the counting is set at the predetermined initial value during the duration that the third switch 121 operates in the ON state); when(ever) it is determined, based on the pressure sensing signal, that the receiving electrode 111 contacts the position detector 2, setting the counting to the predetermined initial value; and when the counting completes at the predetermined target value, setting the power control signal to the second level to cause said fourth switch 1221 to operate in the OFF state.

In application, when the third switch 121 is actuated for the first time, the power circuit 122 outputs the power supply voltage (Vdd), and the processing circuit 114 sets the power control signal to the first level. Then, when the third switch 121 is not actuated and the receiving electrode 111 does not contact the position detector 2 (see FIG. 1) for a while (i.e., a duration required for the processing circuit 114 to count from the predetermined initial value to the predetermined target value), the processing circuit 114 sets the power control signal to the second level, and thus the power circuit 121 stops outputting the power supply voltage (Vdd) to prevent the position indicator 1 from consuming power.

In view of the above, the position indicator 1 of this embodiment has the following advantages:

1. Regardless of the frequency the output signal oscillates at, continuous oscillation of the output signal due to positive feedback can be prevented by at least one of adequately setting the trigger level and the band-pass filter 1121. Therefore, it is relatively easy to design the position indicator 1.

2. Since boost conversion is not required, the position indicator 1 has relatively small power consumption.

3. Since the output of the power supply voltage (Vdd) may be stopped automatically, the position indicator 1 of this embodiment will not keep on consuming power due to negligence of the user.

While this disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A position indicator operatively associated with a position detector that transmits a driving signal, said position indicator comprising:
a signal processing module including
a receiving electrode adapted to receive the driving signal;
an amplifying circuit coupled to said receiving electrode, and amplifying the driving signal received by said receiving electrode to generate an amplified signal;
an oscillating circuit coupled to said amplifying circuit for receiving the amplified signal therefrom, and generating an output signal that oscillates for a time period upon satisfaction of a predetermined threshold condition associated at least with the amplified signal and a predetermined trigger level; and
a transmitting electrode coupled to said oscillating circuit, and adapted to transmit the output signal generated by said oscillating circuit.

2. The position indicator of claim 1, wherein said amplifying circuit is a band-pass amplifying circuit, and includes:
a band-pass filter coupled to said receiving electrode, and band-pass filtering the driving signal received by said receiving electrode to generate a filtered signal; and
an amplifying unit coupled to said band-pass filter for receiving the filtered signal therefrom, and amplifying the filtered signal to generate the amplified signal.

3. The position indicator of claim 2, wherein the output signal oscillates at a frequency outside a pass band of said band-pass filter.

4. The position indicator of claim 1, wherein said signal processing module further includes:
a pressure sensor adapted to sense a contact pressure between said receiving electrode and the position detector to generate a pressure sensing signal; and
a processing circuit coupled to said pressure sensor for receiving the pressure sensing signal therefrom;
based on the pressure sensing signal, said processing circuit estimating the contact pressure between said receiving electrode and the position detector to obtain an estimated pressure value, and generating an oscillation control signal associated with whether said receiving electrode contacts the position detector or not;
said oscillating circuit being coupled further to said processing circuit for receiving the oscillation control signal therefrom, and the threshold condition being associated further with the oscillation control signal.

5. The position indicator of claim 4, wherein said pressure sensor is a micro-electro-mechanical system pressure sensor.

6. The position indicator of claim 4, wherein said signal processing module further includes:
a wireless communication circuit coupled to said processing circuit for receiving the estimated pressure value therefrom, generating a communication signal that carries the estimated pressure value, and transmitting the communication signal wirelessly.

7. The position indicator of claim 4, wherein the amplified signal varies around a predetermined base level, the trigger level is higher than the base level, and the threshold condition includes that the amplified signal is higher than the trigger level and that said receiving electrode contacts the position detector.

8. The position indicator of claim 4, wherein the amplified signal varies around a predetermined base level, the trigger level is lower than the base level, and the threshold condition includes that the amplified signal is lower than the trigger level and that said receiving electrode contacts the position detector.

9. The position indicator of claim 4, wherein said oscillating circuit includes:
a resistor having a first terminal that is coupled to said amplifying circuit for receiving the amplified signal therefrom, and a second terminal;
a first switch coupled to said second terminal of said resistor, and operable between an ON state and an OFF state based on a voltage at said second terminal of said resistor;
a second switch coupled to said processing circuit for receiving the oscillation control signal therefrom, and operable between an ON state and an OFF state based on the oscillation control signal;
a transformer having a primary winding that is coupled to said first and second switches in series, and a secondary winding that is coupled to said transmitting electrode for providing the output signal thereto; and
a capacitor coupled to said secondary winding of said transformer in parallel.

10. The position indicator of claim 4, further comprising a power management module that includes:
a third switch having a first terminal that is adapted to receive a source voltage, and a second terminal, and operable between an ON state and an OFF state; and
a power circuit coupled across said third switch and to said signal processing module, receiving the source voltage, and selectively outputting, based on an operating state of said third switch and a power control signal that switches between a first level and a second level, a power supply voltage associated with the source voltage to power said signal processing module, the power supply voltage being outputted when one of a first condition and a second condition is true, where the first condition is that said third switch operates in the ON state, and the second condition is that the power control signal is at the first level;
wherein said processing circuit of said signal processing module is coupled further to said second terminal of said third switch and said power circuit of said power management module, and generates the power control signal for said power circuit based on the operating state of said third switch and the pressure sensing signal.

11. The position indicator of claim 10, wherein said third switch of said power management module is a normally OFF switch.

12. The position indicator of claim 10, wherein said power circuit of said power management module includes:
a fourth switch coupled to said first terminal of said third switch for receiving the source voltage;
a control unit coupled to said second terminal of said third switch, said fourth switch and said processing circuit of said signal processing module, receiving the power control signal from said processing circuit, and controlling, based on the operating state of said third switch and the power control signal, operation of said fourth switch between an ON state and an OFF state such that said fourth switch operates in the ON state to permit transmission of the source voltage therethrough for a duration when one of the first condition and the second condition is true; and
a voltage regulator coupled to said fourth switch for receiving the source voltage therefrom, and regulating the received source voltage to generate the power supply voltage.

13. The position indicator of claim 10, wherein said processing circuit of said signal processing module performs the following:
counting from a predetermined initial value to a predetermined target value;
when said third switch of said power management module operates in the ON state, setting the power control signal to the first level, and setting the counting to the predetermined initial value;
when it is determined, based on the pressure sensing signal, that said receiving electrode contacts the position detector, setting the counting to the predetermined initial value; and
when the counting completes at the predetermined target value, setting the power control signal to the second level to cause said fourth switch to operate in the OFF state.

14. The position indicator of claim 1, wherein the output signal oscillates at a frequency higher than or equal to that of the driving signal.
